(19) United States
(12) Patent Application Publication
(10) Pub. No.: US 2026/0008254 A1
(43) Pub. Date: Jan. 8, 2026

(54) COMPOSITE FLOOR CONTAINING FIBER LAYER

(71) Applicant: NATURE NEW MATERIAL TECHNOLOGY (JIANGSU) CO., LTD., Huaian (CN)

(72) Inventors: Zhitao LIU, Huaian (CN); Xiaobo ZHOU, Huaian (CN)

(73) Assignee: NATURE NEW MATERIAL TECHNOLOGY (JIANGSU) CO., LTD., Huaian (CN)

(21) Appl. No.: 19/324,690

(22) Filed: Sep. 10, 2025

Related U.S. Application Data
(63) Continuation of application No. PCT/CN2023/089606, filed on Apr. 20, 2023.

(30) Foreign Application Priority Data
Mar. 30, 2023 (CN) 202310324491.4

(51) Int. Cl. B32B 7/12; B32B 9/00; B32B 9/04

(52) U.S. Cl. CPC B32B 7/12; B32B 9/002; B32B 9/047; B32B 2307/558; B32B 2307/72; B32B 2307/7376; B32B 2471/00

(57) ABSTRACT

A composite floor with a fiber layer includes: a stone layer, with a thickness between 0.1 mm and 10 mm; an adhesive layer, located beneath the stone layer; and a fiber layer, located beneath the adhesive layer, with a thickness between 0.01 mm and 2 mm. This composite floor, by compounding the stone layer and the fiber layer, has better impact resistance and excellent overall structural mechanical properties compared to traditional stone flooring, while the thickness of the wall is significantly reduced. It is lightweight, which facilitates transportation, and has super strong impact resistance, and is not prone to cracking.

### CROSS-REFERENCE TO RELATED APPLICATIONS

This application is a continuation of International Application No. PCT/CN2023/089606, filed on Apr. 20, 2023, which claims priority to Chinese Patent Application No. 202310324491.4, filed on Mar. 30, 2023. All of the aforementioned applications are incorporated herein by reference in their entireties.

### TECHNICAL FIELD

This disclosure relates to the field of building materials, and further to floor decoration materials. Furthermore, it relates to a composite floor with a fiber layer.

### BACKGROUND

Flooring, as a surface layer for the floor or story of a house, is a widely used building material. Traditional flooring can include wood flooring, which, according to structure classification, includes laminate wood flooring, engineered wood flooring, bamboo flooring, cork flooring, and multi-layer solid wood flooring. While these types of flooring have advantages such as a beautiful appearance and temperature regulation, their installation process is complex (e.g., solid wood flooring requires pre-installation of keels), maintenance is difficult, and they are prone to arching, warping, deformation, or making noise when walked on. Additionally, flooring materials for a house's floor or story can also include stone or tile materials. The usual installation process for this type of material includes: soaking in water, determining the joint width, applying mortar, tiling, and grouting. Stone or tile as a decorative material presents many problems. Because the installation process involves materials like mortar, the alkaline substances in these materials can easily penetrate the stone and affect its outer surface, leading to yellowing and alkali return. Furthermore, since stone or tile itself is a brittle material, it is prone to warping or cracking. In addition, because stone is heavy and thick (the thickness of floor stone is usually more than 15 mm), a lot of time and money is spent on transportation and assembly. Also, similar to wood flooring, the installation process for stone or tile is complex, making it unsuitable for the current DIY (Do-It-Yourself) decoration style. Adopting traditional installation methods significantly increases the overall decoration time.

Moreover, during a second renovation of a house, the original flooring materials form a considerable height. To replace existing flooring, tiles, or stone, it is often necessary to break up the stone, tile, or wood flooring and the adhesive materials underneath, and then reinstall new flooring. Both removal and reinstallation require a lot of manpower, which is very unfriendly for DIY decoration.

Chinese Patent Application Publication No. CN115726536A discloses an adjustable prefabricated design structure for heavy stone flooring, which, by embedding multiple slide rails in the ground base, allows a sliding mechanism to slide on two adjacent slide rails. The sliding mechanism acts as a support for the stone slab, making it easy to install and adjust, without the need for tenon processing on the stone slab. However, this structure still cannot solve the labor costs associated with the transportation and installation of stone.

U.S. Patent Publication No. U.S. Pat. No. 11,326,357B2 discloses a floor element, which includes a decorative layer containing a brittle material, a resin material that penetrates the bottom surface of the decorative layer, and a support layer below it. However, this brittle material layer is still relatively thick, and the support layer material is a specific material that meets specific strength requirements (bending modulus between 1.5 GPa and 3.5 GPa), and it does not mention its ability to solve the cracking problem of thin stone when combined with it.

### SUMMARY

To solve the above problems, this disclosure provides a composite floor with a fiber layer to at least partially solve the above technical problems.

According to the technical solution of this disclosure, a composite floor with a fiber layer is provided, including: a stone layer, with a thickness between 0.1 mm and 10 mm; an adhesive layer, located beneath the stone layer; a fiber layer, located beneath the adhesive layer, with a thickness between 0.01 mm and 2 mm.

In a further embodiment, the thickness of the stone layer is greater than 0.5 mm and less than 8 mm.

In a further embodiment, the thickness of the stone layer is greater than 1 mm and less than 4 mm.

In a further embodiment, the material of the stone layer includes at least one of the following: limestone, granite, and marble.

In a further embodiment, the material of the adhesive layer includes at least one of the following: hot melt adhesive and thermosetting glue.

In a further embodiment, the area ratio of the stone layer covered by the adhesive layer is greater than 95%.

In a further embodiment, the thickness of the adhesive layer is between 0.1 mm and 1 mm.

In a further embodiment, the material of the fiber layer includes chemical fibers, and the chemical fibers include at least one of the following: aramid, polyester, nylon, acrylic, polypropylene, vinylon, and polyvinyl chloride.

In a further embodiment, the material of the fiber layer includes at least one of the following: carbon fiber and glass fiber.

In a further embodiment, the elastic modulus of the material of the fiber layer is between 5 GPa and 500 GPa.

In a further embodiment, the thickness of the fiber layer is between 0.2 mm and 0.5 mm.

In a further embodiment, the composite floor also includes: a protective film, covering the stone layer, and the protective film is attached to the stone layer and is a transparent material.

In a further embodiment, the material of the protective film includes at least one of the following materials: PU, TPU, or PVC.

In a further embodiment, the composite floor also includes: a bonding layer, located beneath the fiber layer, with an adhesive material on the side closer to the fiber layer for fixed connection with the fiber layer, and a silicone film on the side away from the fiber layer. The silicone film is configured to be adhered to the adhesive material and can be torn off by an external force.

In a further embodiment, the area density of the composite floor is between 3 kg/m² and 30 kg/m².

In a further embodiment, the surface of the stone layer of the composite floor shows no cracks when impacted by a 1 kg stainless steel ball freely dropped from a height of 1 meter.

In a further embodiment, the stone layer of the composite floor has a chamfered structure.

In a further embodiment, the surface of the stone layer has at least one of the following textured finishes: grooved structure, mirrored or smooth finish, matte finish, litchi finish, leather finish, washed finish, and antiqued finish.

In a further embodiment, the edge of the fiber layer includes a buckle structure, configured to fixedly connect adjacent composite floors by means of a buckle.

In a further embodiment, there are multiple composite floors, and each composite floor is fixedly connected to each other through the buckle structure of the fiber layer.

The composite floor of this disclosure, through the cooperation of the stone layer and the fiber layer, has better impact resistance and excellent overall structural mechanical properties compared to traditional stone flooring, while the thickness of the wall is significantly reduced. It is lightweight, which facilitates transportation, and has super strong impact resistance, making it less prone to cracking.

The composite floor of this disclosure, by setting an adhesive layer, can fundamentally prevent the stubborn problems of yellowing and alkali return caused by the base layer in natural stone.

### BRIEF DESCRIPTION OF THE DRAWINGS

To more clearly illustrate the technical solutions of the embodiments of this disclosure, a brief introduction to the drawings required for the description of the embodiments is provided below. It is obvious that the drawings in the following description are only some embodiments of this disclosure. For those skilled in the art, other drawings can be obtained based on these drawings without creative effort.

FIG. 1 is a schematic cross-sectional view of a composite floor with a fiber layer according to one embodiment of this disclosure.

FIG. 2 is a schematic perspective view of the composite floor with a fiber layer of the embodiment shown in FIG. 1.

FIG. 3 is a schematic cross-sectional view of a composite floor with a fiber layer according to another embodiment of this disclosure.

FIG. 4 is a schematic perspective view of the composite floor with a fiber layer of the embodiment shown in FIG. 3.

FIG. 5 is a schematic cross-sectional view of a composite floor with a fiber layer according to yet another embodiment of this disclosure.

FIG. 6 is a schematic cross-sectional view of a composite floor with a fiber layer according to one embodiment of this disclosure.

FIG. 7 is a schematic structural view of a combination of multiple composite floors with a fiber layer shown in FIG. 6 according to one embodiment of this disclosure.

FIG. 8 is a flowchart of a method for preparing a composite floor with a fiber layer according to one embodiment of this disclosure.

FIG. 9 is a flowchart of a method for preparing a composite floor with a fiber layer according to another embodiment of this disclosure.

### DETAILED DESCRIPTION OF THE EMBODIMENTS

To facilitate an understanding of the principles and features of various embodiments of this disclosure, various illustrative embodiments are explained below. While the exemplary embodiments of this disclosure are explained in detail, it should be understood that other embodiments are also considered. Therefore, the scope of this disclosure is not intended to be limited to the details of the construction and arrangement of the components described in the following description or examples. This disclosure can be realized in other embodiments and can be practiced or implemented in various ways. Furthermore, specific terminology will be used for clarity in describing the exemplary embodiments.

In this disclosure, the term “and/or” may be used. As used in this disclosure, the term “and/or” means one or the other or both (for example, A and/or B means A or B or both A and B).

Furthermore, in describing the exemplary embodiments, terms will be used for clarity. Each term should be considered in the broadest sense understood by those skilled in the art and includes all theoretical equivalents that operate in a similar manner to achieve a similar purpose. It should be understood that embodiments of the disclosed technical solutions can be implemented without these specific details. In some cases, known methods, structures, and terminology in the prior art are not shown in detail so as to be able to focus on the inventive content of this disclosure.

In this disclosure, “an embodiment,” “one embodiment,” “some embodiments,” etc., means that the solution described in the corresponding embodiment may include specific features, method steps, parameters, structures, or connection relationships, but not every embodiment necessarily includes the specific features, method steps, parameters, or connection relationships. In addition, the repeated use of “one embodiment” does not necessarily refer to the same embodiment, although this possibility exists.

In this disclosure, a certain specific value and/or a value similar to the specific value is described by “approximately” or “similar” or “substantially.” When this descriptive range is used, the corresponding exemplary embodiment includes a corresponding range from one specific value and/or to another specific value. In addition, “about” refers to an acceptable error range of a specific value as determined by those skilled in the art. This will depend in part on how the specific value is measured or determined, i.e., values within the measurement system error range are all included in the meaning represented by “about.”

In this disclosure, the term “comprising” or “containing” or “including” means having a corresponding compound, element, particle, or method step in the composition, compound, material structure or component, or method step, but does not exclude the presence of other compounds, elements, particles, or method steps.

In this disclosure, the terms “above” and “below” indicate that the position of one structural layer is above or below another structural layer. The structural layers can be in direct contact or indirect contact.

In this disclosure, the term “fiber” is a general term for slender substances whose length is more than a thousand times their diameter and which have certain flexibility and strength.

In this disclosure, it needs to be understood that when one or more method steps are mentioned, it does not exclude the existence of additional method steps or intermediate method steps between these explicitly defined steps. Similarly, it should also be understood that mentioning one or more material components in a composition does not exclude the presence of other explicitly defined components.

In this disclosure, any dimensions listed in the exemplary drawings are for illustrative purposes only and are not intended to limit the content of this disclosure. Considerations and expectations of other dimensions and proportions will be included in the scope of this disclosure.

The stone flooring of the prior art, its stone thickness is usually greater than 15 mm, and the overall thickness and weight are relatively large. As mentioned above, using conventional laying methods requires a lot of labor and time; furthermore, this traditional stone flooring has problems such as yellowing, alkali return, poor impact resistance, and being prone to cracking during use.

The embodiments of this disclosure provide a composite floor with a fiber layer, which includes a stone layer, an adhesive layer, and a fiber layer. Among them, the thickness of the stone layer is significantly reduced compared to the stone layer of the prior art, which also reduces the overall floor weight (by more than 50% or even more than 85%), thereby reducing the cost of transportation and laying. By compounding the fiber layer with the stone layer, the properties of the fiber material can compensate for the shortcomings of the stone material itself. While reducing its own weight, it can still improve the impact resistance of the composite floor. Then, the stone layer and the fiber layer are structurally bonded together by an adhesive layer to form an integrated structure, which improves the overall strength. In addition, due to the barrier of the adhesive layer, the phenomena of yellowing and alkali return on the surface of the stone are avoided.

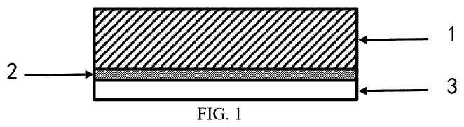

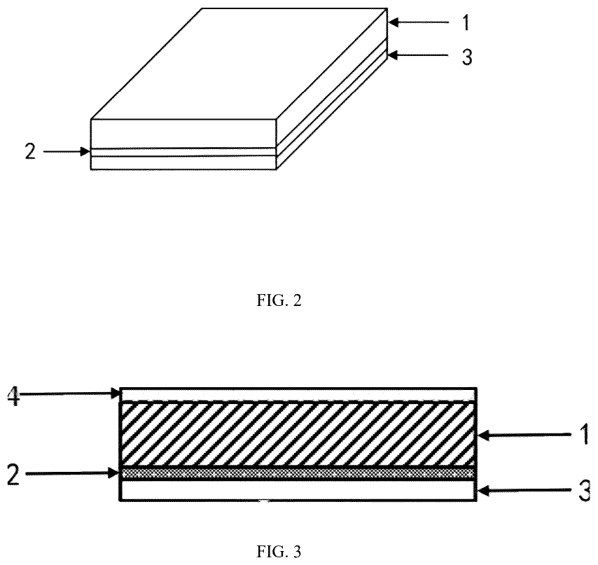

FIG. 1 is a schematic cross-sectional view of a composite floor with a fiber layer according to one embodiment of this disclosure. Referring to the composite floor shown in FIGS. 1 and 2, it includes an upper stone layer 1, a middle adhesive layer 2, and a lower fiber layer 3. Those skilled in the art should understand that the figures are only schematic structures, and the layered structure of the actual technical solution may have different additions or variations. For example, other layered structures may be included between the layers.

Regarding the upper stone layer 1, its main function is to provide surface decoration and strength support. The stone layer 1 will be specifically introduced below.

In some embodiments, the thickness of the stone layer 1 is between 0.1 mm and 10 mm. This thickness is significantly lower than the thickness of traditional stone flooring, which greatly reduces the overall weight and thickness of the floor, making it convenient for decoration and direct DIY attachment by users. If the thickness of the stone layer is less than 0.1 mm, the processing cost would be higher, and if the stone layer is too thin, its strength cannot be guaranteed and it is prone to cracking. If the thickness of the stone layer is greater than 10 mm, the cost of transportation and installation at the corresponding thickness will increase significantly, and the overall floor cannot achieve a lightweight, high-impact resistance effect. Optionally, the thickness of the stone layer 1 is greater than 0.5 mm and less than 8 mm. The stone in this thickness range can adapt to the conventional mechanical requirements of floor installation, that is, it meets certain impact resistance and strength while minimizing the weight of the stone. Furthermore, optionally, the thickness of the stone layer 1 is greater than 1 mm and less than 4 mm. Stone in this thickness range can further have a certain bending radius to meet the needs of curved surface installation. Since the thickness of the stone layer is less than the stone thickness of the prior art, the cutting speed needs to be reduced during cutting to prevent damage to the stone layer 2.

In some embodiments, the material of the stone layer 1 is natural stone and/or artificial stone. The material of the stone layer 1 is optionally natural stone. The natural stone includes but is not limited to: sandstone, granite, limestone, slate, quartzite, and marble. Preferably, the natural stone includes limestone, granite, and marble, as these types of natural stone are suitable for use as architectural veneer stone. More preferably, the natural stone includes limestone, which belongs to limestone. The advantages of limestone are sound insulation, thermal insulation, moisture absorption, low thermal conductivity, elegant texture, high comfort to the touch, and almost zero radiation. Optionally, the material of the stone layer 1 can also be artificial stone. A typical preparation method for this artificial stone is to use unsaturated polyester resin as a binder, and mix it with inorganic powder materials such as natural marble, calcite, dolomite, silica sand, glass powder, etc., as well as an appropriate amount of flame retardant, colorant, etc., to form and cure it through methods such as batching, mixing, porcelain casting, vibratory compression, and extrusion.

In some embodiments, the common porosity of the stone layer 1 can be selected. Since the adhesive layer already reduces the phenomena of yellowing and alkali return, any material with various porosities can be selected for the stone layer 1 to avoid the above-mentioned phenomena in the composite material.

In some embodiments, the shape of the stone layer 1 unit in the composite floor unit is various shapes known in the prior art, and this disclosure is not limited thereto, including but not limited to hexagons, diamonds, squares, and rectangles. Optionally, the size of the stone layer unit in the composite floor unit is various shapes and sizes that meet the requirements of the corresponding region or country, and this disclosure is not limited thereto. Typical sizes can be 305 mm×305 mm, 305 mm×610 mm, 610 mm×610 mm, 610 mm×915 mm. It should be noted that the above sizes are only examples, and the actual size can be selected according to the floor tile or ceiling standards of the relevant country or region.

In some embodiments, the surface of the stone layer 1 in the composite floor unit has a textured finish. This includes but is not limited to a grooved structure, a mirrored/smooth finish, a matte finish, a litchi finish, a leather finish, a washed finish, and an antiqued finish, to improve the wear resistance, aesthetics, and other effects of the composite floor.

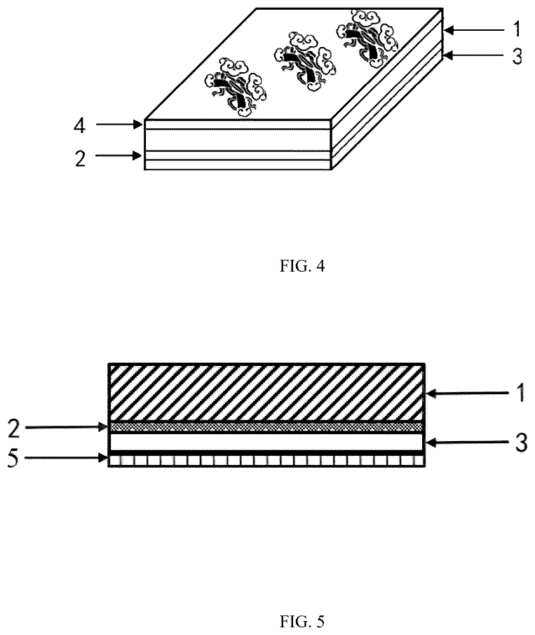

In some embodiments, the composite floor may further include a protective film, which covers the stone layer 1. FIG. 3 is a schematic cross-sectional view of a composite floor with a fiber layer according to another embodiment of this disclosure. FIG. 4 is a schematic perspective view of the composite floor with a fiber layer of the embodiment shown in FIG. 3. Referring to FIGS. 3 and 4, the composite floor also has a protective film 4 on the outside of the stone layer 1. This protective film is attached to the outer surface of the stone layer 1 and plays a protective role during transportation and installation to prevent accidental scratches and bumps. After decoration is complete, the protective film can be torn off by an external force. Optionally, the material of the protective film 4 includes but is not limited to PVC (polyvinyl chloride), PU (polyurethane), TPU (thermoplastic polyurethane elastomer). Preferably, the material of the protective film 4 is PU. The advantage of this type of material is that it has a certain tensile strength, which can provide a better adhesion effect and protect the stone layer it covers. In addition, as shown in FIG. 3, the protective film can also optionally be printed with a specific pattern, trademark, company name, or logo.

The adhesive layer 2 in the composite floor is mainly used to fix and bond the stone layer 1 and the fiber layer 3, and to block alkaline and other substances from penetrating the stone layer 1. The adhesive layer will be specifically introduced below.

In some embodiments, the material of the adhesive layer 2 includes an organic adhesive. An organic adhesive is an adhesive that uses an organic substance as the main component for bonding. Optionally, the organic adhesive includes hot melt adhesive and thermosetting glue (such as epoxy resin). The corresponding types of organic adhesives can block alkaline substances and provide good adhesion between the stone layer 1 and the fiber layer 3. Preferably, the organic adhesive is an alkali-resistant adhesive. This alkali-resistant adhesive is an adhesive that can resist corrosion by alkaline media, including but not limited to alkali-resistant adhesives composed of furan resin, epoxy resin, chlorosulfonated polyethylene rubber, vinyl resin, unsaturated polyester resin, polymer cement mortar, pressure-sensitive adhesive, acrylic resin, vinyl acetate resin, polyurethane, polyurea resin, etc., as a base. More preferably, the organic adhesive includes epoxy resin, polyurethane, and pressure-sensitive adhesive, mainly for cost and bonding effect considerations. Alkali-resistant adhesives can generally include components such as resin, plasticizer, filler, cement, flame retardant, and curing agent. The typical process for bonding the stone layer 1 and the fiber layer 3 with the adhesive layer 2 is hot pressing.

In some embodiments, the adhesive layer 2 should fully cover the stone layer 1 to provide a good barrier effect. Optionally, the adhesive layer 2 covers more than 95% of the bottom surface area of the stone layer 1. More preferably, the adhesive layer 2 covers more than 99% of the bottom surface area of the stone layer.

In some embodiments, the thickness of the adhesive layer 2 is between 0.1 mm and 1 mm. Preferably, the thickness is between 0.3 mm and 0.6 mm. An adhesive layer 2 of a certain thickness can provide a better bonding and barrier effect. In addition, for cost and other considerations, the thickness of the corresponding adhesive layer 2 should be maintained within a certain range.

The fiber layer 3 in the composite material contains fiber material, and its main function is to compensate for the shortcomings of the stone material itself (poor impact resistance, heavy weight) and to ensure that the overall composite floor maintains a corresponding strength while reducing the thickness of the stone layer, which can improve the impact resistance of the composite floor. The fiber layer will be specifically described below.

In some embodiments, the material of the fiber layer 3 includes natural fibers and chemical fibers. Among them, natural fibers are fibers that exist in nature and can be obtained directly, including plant fibers, animal fibers, and mineral fibers. Among them, the chemical fibers include man-made fibers, synthetic fibers, and inorganic fibers.

In some embodiments, man-made fibers include but are not limited to viscose fibers and acetate fibers. In some embodiments, synthetic fibers include but are not limited to: aramid, polyester, nylon, acrylic, polypropylene, vinylon, and polyvinyl chloride. The basic substance of polyester is polyethylene terephthalate, and its chemical formula is [—OC—COOCH₂CH₂O—]ₙ, so it is also called polyester fiber. Nylon is a class of poly (hexamethylene adipamide) obtained by the polycondensation of hexamethylenediamine and adipic acid, and its chemical formula for the long-chain molecule is: H—[HN(CH₂)₆NHCO(CH₂)+CO]—OH. Another class is obtained by the polycondensation or ring-opening polymerization of caprolactam, and its chemical formula for the long-chain molecule is: H—[NH(CH₂)₅CO]—OH. Acrylic is also known as polyacrylonitrile fiber, and its chemical formula is: [—CH₂—CHCN—]ₙ. The chemical formula for polypropylene is: [—CH₂—CH(CH₃)—]ₙ. Polypropylene is a synthetic fiber made from propylene, a byproduct of petroleum refining, and is also called polypropylene fiber. Vinylon is the trade name for polyvinyl alcohol acetal fiber, also known as vinylon. Polyvinyl chloride is a synthetic fiber made from polyvinyl chloride or its copolymers. Preferably, the fiber material is selected from at least one of aramid, polyester, nylon, acrylic, polypropylene, vinylon, and polyvinyl chloride. This type of fiber meets environmental standards and has a high initial modulus. More preferably, the fiber material is selected from aramid materials, which have a relatively higher initial modulus.

In some embodiments, the material of the fiber layer 3 is inorganic fiber. Inorganic fibers are made from natural inorganic materials or carbon-based polymer fibers, which are spun artificially or carbonized directly. Inorganic fibers include glass fiber, metal fiber, and carbon fiber.

In some embodiments, the material of the fiber layer 3 is optionally an elastic fiber material with an elastic modulus of 5 GPa-500 GPa. Preferably, it is 50 GPa-500 GPa. Optional elastic materials include glass fiber, carbon fiber, or aramid. More preferably, it is aramid. The elastic modulus of these related materials is relatively large, which can improve the mechanical properties of the overall composite material.

In some embodiments, the fiber layer 3 has a specific fracture strength to ensure that the stone layer does not crack under external impact. The corresponding fracture strength is measured as follows: the sample is stretched with a strength-elongation tester under specified conditions until it breaks, and the breaking strength and elongation are obtained, and the fracture strength is calculated from the breaking strength and linear density. In some embodiments, the thermal expansion coefficient of the fiber layer 3 is preferably matched with that of the stone layer. The thermal expansion coefficient of stone is basically of the order of 10-6. In this case, to better match the thermal expansion coefficient of the stone, at least one of the following fibers is preferred: synthetic fibers (including aramid, polyester, acrylic, polypropylene, vinylon, and polyvinyl chloride), glass fiber, and carbon fiber. In some embodiments, when selecting the material for the fiber layer, its fire resistance, alkali resistance, acid resistance, and water resistance are also considered to further improve the relevant performance of the overall composite panel, and optional materials include glass fiber, carbon fiber, and aramid.

In some embodiments, the thickness of the fiber layer 3 is between 0.01 mm and 2 mm. If the thickness of the fiber layer 3 exceeds 2 mm, it will affect the overall thickness of the composite panel. If it is less than 0.01 mm, the overall bending strength cannot be guaranteed and cracking cannot be prevented. More preferably, the thickness of the fiber layer is between 0.2 mm and 0.5 mm. The overall form of the fiber layer 3 can be a fiber cloth or a fiber mesh.

In some embodiments, the composite floor also includes a bonding layer 5. FIG. 5 is a schematic cross-sectional view of a composite floor with a fiber layer according to yet another embodiment of this disclosure. As shown in FIG. 5, the bonding layer 5 is located beneath the fiber layer 3. The side of the bonding layer closer to the fiber layer 3 has an adhesive material for fixed connection with the fiber layer, and the side away from the fiber layer 3 contains a silicone film. The silicone film is configured to be adhered to the adhesive material and can be torn off by an external force. During actual installation, the silicone film is torn off by an external force to allow the adhesive material to directly contact the ground, which saves the process of pre-applying waterproof adhesive to the ground. In addition, this adhesive material can also further block alkaline components from penetrating the stone layer 1.

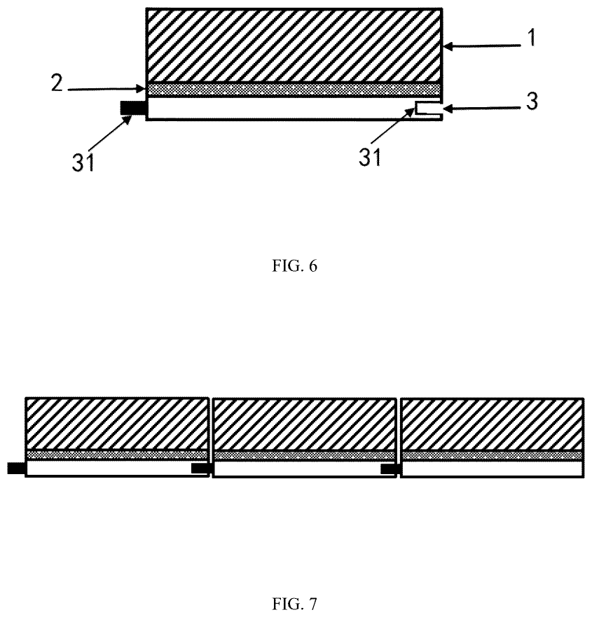

In some embodiments, the edge of the fiber layer 3 includes a buckle structure. FIG. 6 is a schematic cross-sectional view of a composite floor with a fiber layer according to one embodiment of this disclosure. As shown in FIG. 6, the buckle structure 31 is configured to fix adjacent composite floors together by means of a buckle. FIG. 7 is a schematic structural view of a combination of multiple composite floors with a fiber layer shown in FIG. 6 according to one embodiment of this disclosure. In combination with FIGS. 6 and 7, the corresponding buckle structure 31 can easily realize the quick splicing between composite floors, saving the overall installation time.

In some embodiments, the composite panel includes a chamfered structure. In DIY processes, a crystallization treatment process may not be included, and there may be unevenness between panels. To compensate for this situation during the installation process, at least the stone layer of the composite panel includes a chamfered structure. In addition, the chamfered structure can also reduce edge chipping during transportation and installation. Optionally, the chamfered edge is a 45-degree bevel, a chamfer with a rounded corner, a ¼ rounded corner, or a ½ rounded corner.

In some embodiments, the area density of the composite panel is between 3 kg/m² and 30 kg/m². This area density is significantly reduced compared to traditional stone panels, which can significantly reduce weight, lower costs, save stone, and improve installation efficiency. Preferably, the area density of the composite panel is between 3 kg/m² and 15 kg/m². The area density within this range is smaller, and it can ensure corresponding strength and meet good impact requirements.

The composite floor of this disclosure, comprising the above-mentioned stone layer 1, adhesive layer 2, and fiber layer 3, has many advantages. First, it has excellent physical properties. It can have a high heavy-duty impact resistance effect, and the impact resistance level far exceeds the standard requirement of 10J. This performance can ensure that the KN panel is not easily cracked or damaged during production, handling, installation, and use, which solves a major problem of natural stone being prone to cracking and damage. For ultra-thin panels (the thickness of the stone layer is 1-3 mm), they can be bent and installed on a curved surface, and can have slight deformation performance. Designers can use this performance for curved surface installation design, improving efficiency and reducing costs and saving stone. It can fundamentally prevent the stubborn problems of yellowing, alkali return, and cracking caused by the base layer in natural stone. In some embodiments, the installation method formed by self-leveling hard base+waterproof layer+thin-layer process+panel installation can greatly reduce the moisture and alkaline substance lesions that cause yellowing and alkali return problems. Through multi-layer waterproof barriers, it can block the erosion of water and alkaline substances, and fundamentally prevent the two major problems of natural stone being prone to yellowing and alkali return caused by the base layer. Moreover, the hard self-leveling can effectively improve the hollowing phenomenon of the base layer and improve the stubborn problem of natural stone being prone to cracking. Second, it has a lightweight and weight-reducing effect. The weight of the panel in this solution is about 3 kg-15 kg per square meter, and the cost of transportation and secondary handling will be greatly reduced. The effect of being lightweight is that it can reduce the work intensity of installers and improve work efficiency. At the same time, being lightweight also allows installers to easily adjust the position of the panel to ensure precise installation results. Third, it is healthy and environmentally friendly. The composite panel of this disclosure can more effectively realize resource utilization, increasing the utilization rate of natural stone, a mineral resource, by 4-8 times, making it more low-carbon and environmentally friendly. In addition, the composite panel can be produced and transported with less energy consumption, reducing the energy consumption in the production and transportation process by 80%. This composite panel brings a more environmentally friendly production process, with zero emissions, zero wastewater, and zero waste gas generation during the production process, and solid waste can be recycled. Furthermore, the composite panel creates a healthier living environment by solving the stubborn problem of stone cracking, with no space for mold growth, and creating a healthier living environment. The materials of each layer of the composite panel are preferably green materials and can be used with confidence. Fourth, safety performance is improved. Due to the light weight of the material, it greatly avoids industrial accidents. During installation, it can effectively avoid industrial accidents such as crushing and smashing. It can also effectively solve the safety hazard of dry-hung stone on the wall cracking and falling. Fifth, it has a cost advantage. Based on the thickness and specific materials of each layer, the costs in terms of labor, transportation, handling, etc., can be optimized, and the overall cost can be reduced by more than 30%. Sixth, the installation process is simplified. A new, revolutionary natural stone installation process adapted to this layered structure has emerged, which is healthier, more environmentally friendly, simpler, more efficient, and has a longer service life.

To further elaborate on the specific details of this disclosure, the content of this disclosure will be further explained through specific examples and comparative examples.

### Example 1

Preparation of the stone layer: The stone layer is prepared from marble material by cutting. The thickness of the cut stone layer is 2 mm, the length of the stone layer is 900 mm, and the width is 600 mm. Preparation of the fiber layer: The fiber layer is prepared from polyester material. The fiber layer is processed to a thickness of 0.1 mm and the same size as the stone layer. Preparation of the composite panel: The stone layer and the fiber layer are bonded and pressed together with a hot melt adhesive. The thickness of the adhesive layer is measured to be 0.2 mm.

### Weight Testing:

The prepared composite panel is tested, and the total weight of the composite panel is measured to be 3.79 kg. The area density of the composite floor is calculated to be 7.02 kg/m².

### Alkali Return Performance Testing:

### The Detection Method Includes:

a. Preparation of an alkaline solution (saturated calcium hydroxide): An alkaline solution is prepared by adding 1.2 g of calcium hydroxide to 1000 mL of distilled water at a temperature of (23±2° C.) The solution is fully stirred. The pH value of this solution can reach 12-13, which is approximately equal to the PH value when cement solidifies.
b. The alkaline solution is poured into a sealable plastic container, and small stones with the same height as the liquid level are placed in the liquid to ensure that the total area of the stones is no more than 10% of the liquid surface area. Three panels prepared in the above step are selected, their surfaces are polished until the reflectance at a 60-degree angle is greater than 60%, and the four edges of the sample are sealed with a mixture of paraffin and rosin (mass ratio 1:1). The samples are placed on the small stones so that the lower surface of the sample remains in contact with the liquid surface until the specified time.
c. The samples are taken out every 24 hours to observe the changes in the surface by reflection.
d. Measurement time: 90 days.

### Measurement Results:

No loss of gloss or change was observed on the three composite panels during the measurement period.

### Impact Resistance Testing:

### Measurement Method:

a. Three composite panels are selected and cut into samples with dimensions of 300 mm×300 mm, and laid on a floor with a flatness deviation of no more than 2 mm.
b. A 1 kg stainless steel ball is freely dropped from a height of 1 meter to impact the sample, and the changes in the sample are observed.

### Measurement Results:

No changes were observed on the surface of the stone layer of the three composite panels.

### Example 2

### Preparation of the Stone Layer:

The stone layer is prepared from limestone material by cutting. The thickness of the cut stone layer is 5 mm, the length of the stone layer is 900 mm, and the width is 900 mm. Preparation of the fiber layer: The fiber layer is prepared from aramid material. The fiber layer is processed to a thickness of 0.5 mm and the same size as the stone layer. Preparation of the composite panel: The stone layer and the fiber layer are bonded and pressed together with epoxy resin. The thickness of the adhesive layer is measured to be 0.3 mm.

### Weight Testing:

The prepared composite panel is tested, and the total weight of the composite panel is measured to be 13.06 kg. The area density of the composite floor is calculated to be 16.12 kg/m². Alkali return performance testing:

### The Detection Method Includes:

a. Preparation of an alkaline solution (saturated calcium hydroxide): An alkaline solution is prepared by adding 1.2 g of calcium hydroxide to 1000 mL of distilled water at a temperature of (23±2° C.) The solution is fully stirred. The pH value of this solution can reach 12-13, which is approximately equal to the PH value when cement solidifies.
b. The alkaline solution is poured into a sealable plastic container, and small stones with the same height as the liquid level are placed in the liquid to ensure that the total area of the stones is no more than 10% of the liquid surface area. Three panels prepared in the above step are selected, their surfaces are polished until the reflectance at a 60-degree angle is greater than 60%, and the four edges of the sample are sealed with a mixture of paraffin and rosin (mass ratio 1:1). The samples are placed on the small stones so that the lower surface of the sample remains in contact with the liquid surface until the specified time.
c. The samples are taken out every 24 hours to observe the changes in the surface by reflection.
d. Measurement time: 90 days.

### Measurement Results:

No loss of gloss or change was observed on the three composite panels during the measurement period.

### Impact Resistance Testing:

### Measurement Method:

a. Three composite panels are selected and cut into samples with dimensions of 300 mm×300 mm, and laid on a floor with a flatness deviation of no more than 2 mm.
b. A 1 kg stainless steel ball is freely dropped from a height of 1 meter to impact the sample, and the changes in the sample are observed.

### Measurement Results:

No changes were observed on the surface of the stone layer of two composite panels, and one had a slight indentation on the surface.

### Comparative Example 1

A marble stone slab with a thickness of 20 mm and dimensions of 900 mm×600 mm is prepared.

### Weight Testing:

The prepared marble stone slab is tested, and its weight is measured to be 30.24 kg. The area density is 56 kg/m².

### Alkali Return Performance Testing:

The test conditions are the same as in Example 1.

### Measurement Results:

Within the experimental period, all three marble stone slabs showed obvious loss of gloss after 24 hours, visible white spots appeared on the surface after 48 hours, and the area and thickness of the white spots became larger and thicker in subsequent observations.

### Impact Resistance Testing:

The test conditions are the same as in Example 1.

### Measurement Results:

All three marble stone slabs were broken.

The above test results are summarized in Table 1 below:

TABLE 1

| | Thickness | Thickness | Thickness | | | |
|---|---|---|---|---|---|---|
| | of first | of bonding | of second | Area | Impact | |
| | structural | layer | structural | density | resistance | Alkali return |
| | layer (mm) | (mm) | layer (mm) | (kg/m²) | performance | performance |
| Example1 | 2 | 0.2 | 0.1 | 7.02 | No changes | No loss of |
| | | | | | | gloss, no |
| | | | | | | white spots |
| Example2 | 5 | 0.3 | 0.5 | 16.12 | No changes | No loss of |
| | | | | | | gloss, no |
| | | | | | | white spots |
| Comparative | 20 | — | — | 56 | All broken | Loss of gloss, |
| Example1 | | | | | | white spots |

From the results in the table above, it can be seen that compared with the stone flooring of the prior art, the composite panels of the embodiments of this disclosure are lighter, thinner, and have higher alkali return resistance and impact resistance.

The typical installation process for the above composite floors can include two main types: one is for renovation on existing decoration, and the other is for new house decoration.

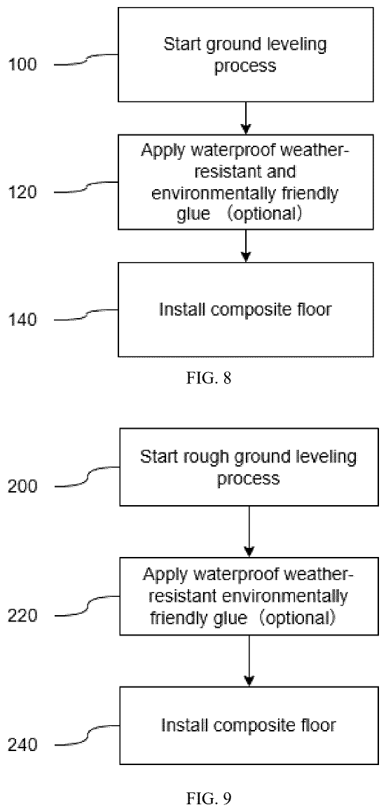

FIG. 8 is a flowchart of a method for preparing a composite floor with a fiber layer according to one embodiment of this disclosure. This flowchart corresponds to the case of new house decoration. Since a new house has not been decorated, the ground may have slopes or unevenness, so it is necessary to first apply step S100: ground leveling process, which typically includes cement mortar ground leveling or self-leveling cement leveling. Subsequently, an optional process step S120: applying waterproof weather-resistant and environmentally friendly glue can be further implemented. In some embodiments, the fiber layer 3 is not attached with a bonding layer, so it is necessary to pre-apply a layer of weather-resistant and environmentally friendly glue on the ground. It can be foreseen that when the fiber layer 3 is already attached with a bonding layer, this step S120 can be omitted. After step S120, step S140: composite floor installation can also be implemented, which is to orderly paste the composite floors on the ground to form an integrated structure. Further optionally, after step S140, a step of crystallization treatment for the composite floors can also be included. The typical crystallization treatment process can specifically include: first, thoroughly cleaning the surface of the marble; mixing the crystallization powder with pure water to form a paste and applying it to the grinding pad; and starting grinding under a certain load. After the surface of the stone layer forms a high-gloss crystalline surface, a water absorption machine is used to suck up the residual paste on the ground; rinse and dry with water; and polish with a polishing pad to make the ground surface completely dry and achieve a glossy effect. Of course, in some embodiments, if the composite floor has a protective film, this crystallization treatment process can be omitted.

FIG. 9 is a flowchart of a method for preparing a composite floor with a fiber layer according to one embodiment of this disclosure. This flowchart corresponds to the case of renovation on existing decoration. It should be noted that the composite floor of the embodiments of this disclosure is especially suitable for this situation, because the original ground is already relatively flat, and the thickness of the composite floor of this disclosure is relatively thin, it can be directly covered on the original ground (without destroying the original floor), thus greatly simplifying the installation process. Since a new house has not been decorated, the ground may have slopes or unevenness, so it is necessary to first apply step S200: rough ground leveling process, which mainly involves repairing damaged parts of the original ground. Under specific conditions, ground repair may not even be necessary. Subsequently, an optional process step S220: applying waterproof weather-resistant and environmentally friendly glue can be further implemented. In some embodiments, the fiber layer 3 is not attached with a bonding layer, so it is necessary to pre-apply a layer of weather-resistant and environmentally friendly glue on the ground. It can be foreseen that when the fiber layer 3 is already attached with a bonding layer, this step S220 can be omitted. After step S220, step S240: composite floor installation can also be implemented, which is to orderly paste the composite floors on the ground to form an integrated structure. Further optionally, after step S240, a step of crystallization treatment for the composite floors can also be included. The typical crystallization treatment process can specifically include: first, thoroughly cleaning the surface of the stone; mixing the crystallization powder with pure water to form a paste and applying it to the grinding pad; starting grinding under a certain load; after the surface of the stone layer forms a high-gloss crystalline surface, a water absorption machine is used to suck up the residual paste on the ground; rinse and dry with water; and polish with a polishing pad to make the ground surface completely dry and achieve a glossy effect. Of course, in some embodiments, if the composite floor has a protective film, this crystallization treatment process can be omitted.

Under the overall concept of the specific composite floor materials and structures of this disclosure, the corresponding installation process is greatly simplified, and the efficiency of the overall decoration process is improved.

In the above description, for the purpose of illustration, numerous specific details have been set forth to provide a thorough understanding of the various embodiments of this disclosure. However, it will be apparent to those skilled in the art that one or more other embodiments may be practiced without some of these specific details. The specific embodiments described are not intended to be limiting but are illustrative. The scope of this disclosure is not determined by the specific examples provided above, but is only determined by the following claims. In other cases, well-known circuits, structures, devices, and operations have been shown in block diagram form rather than in detail so as not to obscure the understanding of the description. Where appropriate, reference numerals or the ending parts of reference numerals are repeated in the figures to indicate corresponding or similar elements that may optionally have similar characteristics or the same features, unless otherwise specified or apparent.

Various operations and methods have been described. Some methods have been described in a relatively basic manner in a flowchart, but these operations can be optionally added to and/or removed from these methods. In addition, although the flowcharts show a specific order of operations according to various exemplary embodiments, it is understood that the specific order is exemplary. Alternative embodiments can optionally perform these operations in a different manner, combine certain operations, interleave certain operations, and so on. The components, features, and specific optional details of the devices described herein can also be optionally applied to the methods described herein.

What is claimed is:

1. A composite floor with a fiber layer, comprising:
a stone layer, with a thickness between 0.1 mm and 10 mm;
an adhesive layer, located beneath the stone layer; and
a fiber layer, located beneath the adhesive layer, with a thickness between 0.01 mm and 2 mm.

2. The composite floor according to claim 1, wherein the thickness of the stone layer is greater than 0.5 mm and less than 8 mm.

3. The composite floor according to claim 2, wherein the thickness of the stone layer is greater than 1 mm and less than 4 mm.

4. The composite floor according to claim 1, wherein a material of the stone layer comprises at least one of the following: limestone, granite, and marble.

5. The composite floor according to claim 1, wherein the material of the adhesive layer comprises at least one of the following: hot melt adhesive and thermosetting glue.

6. The composite floor according to claim 1, wherein the area ratio of the stone layer covered by the adhesive layer is greater than 95%.

7. The composite floor according to claim 1, wherein the thickness of the adhesive layer is between 0.1 mm and 1 mm.

8. The composite floor according to claim 1, wherein the material of the fiber layer comprises chemical fibers, and the chemical fibers comprise at least one of the following: aramid, polyester, nylon, acrylic, polypropylene, vinylon, and polyvinyl chloride.

9. The composite floor according to claim 1, wherein the material of the fiber layer comprises at least one of the following: carbon fiber and glass fiber.

10. The composite floor according to claim 1, wherein the elastic modulus of the material of the fiber layer is between 5 GPa and 500 GPa.

11. The composite floor according to claim 1, wherein the thickness of the fiber layer is between 0.2 mm and 0.5 mm.

12. The composite floor according to claim 1, wherein the composite floor also comprises: a protective film, covering the stone layer, and the protective film is attached to the stone layer and is a transparent material.

13. The composite floor according to claim 12, wherein the material of the protective film comprises at least one of the following materials: PU, TPU, or PVC.

14. The composite floor according to claim 1, wherein the composite floor also comprises: a bonding layer, located beneath the fiber layer, with an adhesive material on the side closer to the fiber layer for fixed connection with the fiber layer, and a silicone film on the side away from the fiber layer, the silicone film is configured to be adhered to the adhesive material and is capable of being torn off by an external force.

15. The composite floor according to claim 1, wherein the area density of the composite floor is between 3 kg/m² and 30 kg/m².

16. The composite floor according to claim 1, wherein the surface of the stone layer of the composite floor shows no cracks when impacted by a 1 kg stainless steel ball freely dropped from a height of 1 meter.

17. The composite floor according to claim 1, wherein the stone layer of the composite floor has a chamfered structure.

18. The composite floor according to claim 1, wherein the surface of the stone layer has at least one of the following textured finishes: grooved structure, mirrored or smooth finish, matte finish, litchi finish, leather finish, washed finish, and antiqued finish.

19. The composite floor according to claim 1, wherein the edge of the fiber layer comprises a buckle structure, configured to fixedly connect adjacent composite floors by means of a buckle.

20. The composite floor according to claim 19, wherein there are multiple composite floors, and each composite floor is fixedly connected to each other through the buckle structure of the fiber layer.
